(19) United States
(12) Patent Application Publication
(10) Pub. No.: US 2009/0248587 A1
(43) Pub. Date: Oct. 1, 2009

(54) SELECTIVELY NEGOTIATED RIDERSHARE SYSTEM COMPRISING RIDERS, DRIVERS, AND VEHICLES

(76) Inventor: Peter C. VAN BUSKIRK, Newtown, CT (US)

Correspondence Address: INTELLECTUAL PROPERTY / TECHNOLOGY LAW, PO BOX 14329, RESEARCH TRIANGLE PARK, NC, 27709, US

(21) Appl. No.: 12/202,250

(22) Filed: Aug. 30, 2008

Related U.S. Application Data
(60) Provisional application No. 60/969,303, filed on Aug. 31, 2007.

(51) Int. Cl. G06Q 50/00; G06Q 30/00; G06Q 99/00; G06F 17/30; G06N 5/00

(52) U.S. Cl. 705/80; 705/1; 707/5; 706/52

(57) ABSTRACT

A ridesharing system and method involving selected negotiated participation of riders and ride providers. The ridesharing system in a specific implementation involves a computer-implemented capability for computational matching of potential participants in a ridesharing arrangement, wherein such system is adapted for prioritized ranking of target ridesharing attributes by such potential participants, involving allocation by potential participants of quantitative weight within a quantitative total budget of allocatable value to predetermined selection criteria, with such system having an input capability for inputting the allocations of potential participants, and the system being constructed and arranged for effecting the computational matching based on the allocations, with communication capability for outputting results of the computational matching to the potential participants.

### CROSS-REFERENCE TO RELATED APPLICATION

The benefit of priority of U.S. Provisional Patent Application No. 60/969,303 filed Aug. 31, 2007 is hereby claimed under the provisions 35 USC 119.

### FIELD OF THE INVENTION

The use of abundant energy resources, which has become increasing sophisticated, is largely responsible for the high standard of living that characterizes the modern age. These resources are principally comprised of petroleum, natural gas and coal, which, when converted into liquid fuels and electricity, provide the majority of the power used in our society's transportation, technologies, machines, communication equipment, residential heating, etc. In addition to energy production, petroleum and natural gas are also critical ingredients for the “industrial agriculture” practices that support the human population.

Demand for these resources is continually increasing. In addition to growth of the world's population, these energy consuming technologies are becoming more widely available, and their proliferation is closely associated with standard of living increases. At the same time, petroleum and natural gas supplies are increasingly constrained, and production of these natural resources will eventually reach a peak, followed by decline. These trends in supply and demand will cause the price of energy to dramatically increase in the coming decades, and widespread changes in human behavior will be the result.

One of the most promising ways to mitigate these effects will be energy conservation, as a way to reduce energy use, while ideally minimizing any loss in standard or quality of living. Conservation is human behavior modification (individual and group), and is differentiated from efficiency improvements in machines that generate, convert or use energy.

There is a particularly large opportunity to conserve the huge volumes of petroleum fuels currently used for transportation, since there exists a well developed highway infrastructure, coupled with a vast privately owned vehicle fleet, for which the available seats are vastly underutilized. The essential problem is that all but a small fraction of the seats in moving vehicles are empty.

Carpooling has so far been proposed but not widely adopted. To-date there have been a number of community sponsored carpooling/ridesharing schemes, as well as several privately administered businesses recently. These have not met with significant success, because of the lack of motivation for prospective riders or ride providers to share their vehicles with others. As gasoline and diesel prices increase, there may be interest in carpooling and ridesharing, but the majority of users will not change their lifestyles unless there are added benefits.

The automated ridesharing system described herein is a highly flexible scheme that will promote widespread adoption of ridesharing, enabled by 1) compensation schemes to simplify the exchange of money or other valuable assets, and 2) a system level or localized optimization of the ride matching and compensation fixing criteria, such that the system will work more and more effectively as the number of users increases.

There are a variety of benefits to both the user and their community in this type of system is widely adopted by large segments of our population. The benefits include reduced expenditures for fuel, reduced demand for foreign resources, reduced generation of pollutants that include carbon dioxide, and increased positive social interactions within existing and potential communities. Owners of cars and trucks will be able to mitigate the operating (fuel) and capital depreciation expenses by gaining compensation from riders who replace otherwise empty seats.

### DESCRIPTION OF THE RELATED ART

A paper (http://www.si.umich.edu/˜presnick/papers/rideshare/draftscenario.pdf) by University of Michigan professor Paul Resnick describes a hypothetical wireless ridesharing system that includes registration with some personal data and a number of the other matching elements. It does not, however, employ formal compensation negotiation or system optimization mechanisms. It has apparently been pilot tested several times as RideNow (http://www.ridenow.org/).

A system named RidePal was the subject of a business plan created by Jonathan Weinert and others at U C Davis around 2005. The business plan was entered in a business plan competition, but it appears that the system was not continued into development. The business plan describes a wireless and computer based system that includes mention of the concept of ride brokering, and gives an example of a monthly subscription rate.

NuRide (http://www.nuride.com/nuride/main/main.jsp) is a system and corresponding business that that is actively growing. NuRide is an internet based system to share rides with other members, with membership criteria principally based on employer membership. Credits such as frequent flier miles are exchanged but there appears to be no monetary compensation and no capability to determine compensation type or to agree on compensation amount via bid/ask or other similar means.

U.S. Pat. No. 7,082,364 issued to Maria Adamczyk and entitled “Methods, systems and computer program products for ride matching based on current location information” describes systems, methods and computer program products to match a passenger with a driver for a trip to a destination. Candidate driver(s) for the trip are automatically identified based on a current location for the candidate driver(s) responsive to a request from the passenger. The passenger is provided an identification of the identified candidate driver.

US Patent Application 20060155460 issued to Stephen Raney and entitled “Method for GPS carpool rendezvous tracking and personal safety verification” describes GPS enabled cell-phone for ridesharing, focusing on some safety and acknowledgement aspects. The disclosed rendezvous tracking subsystem uses GPS-enabled cell phones communicating with an application server for tracking the whereabouts of carpool participants and for providing on-time status of participants en-route to designated rendezvous points. A safety subsystem is described that can be used to verify safe arrival of participants at carpool destinations. Participants can configure safety subsystem by defining escalation rules and procedures to follow when safety critical events occur. This patent application does not describe value exchange mechanisms or system optimization.

### SUMMARY OF THE INVENTION

The present invention relates to a system that makes vehicle and ride sharing simpler and more efficient, while providing additional benefits that will increase widespread proliferation, societal benefits (social networking) and successful operation (optimization). Additionally a key attribute is a highly flexible way for compensation (monetary or non-cash) to be exchanged. Although automated ridesharing systems have been previously proposed, the current invention incorporates automated and remote communication means to establish and exchange compensation between a rider and a ride provider.

Another aspect of the current invention relates to the ability of the system to optimize how input information is utilized to identify compatible riders and ride providers, in order to increase the likelihood of a successful experience between those parties.

Another aspect of the invention relates to an automated system environment for individuals and groups to devise, implement and iteratively improve their own ridesharing arrangements, each of which may have unique or customized attributes.

In another aspect, the invention relates to a ridesharing system involving selective negotiated participation of riders, drivers and vehicles, the system comprising a computer-implemented capability for computational matching of potential participants in a ridesharing arrangement, wherein the system is adapted for prioritized ranking of target ridesharing attributes by such potential participants, involving allocation by potential participants of quantitative weight within a quantitative total budget of allocatable value to predetermined selection criteria, with the system having an input capability for inputting said allocations of potential participants, and the system being constructed and arranged for effecting said computational matching based on the allocations, and the system including communication capability for outputting results of the computational matching to the potential participants.

In another aspect, the invention relates to a method of operating a consolidated rideshare system involving selective negotiated participation of riders, drivers and vehicles, such method comprising:

establishing a first population of rideshare vehicles, a second associated population of drivers of said rideshare vehicles, and a third population of candidate passengers for said rideshare vehicles;

constructing relationship databases for each of said first, second and third populations;

providing a global internet portal for accessing said relationship databases according to predetermined restrictive access criteria,

generating an output of potential matches of specific riders, drivers and vehicles according to predetermined correlation criteria,

enabling interactive bargaining between riders and drivers for said potential matches, and

verifying a bargained match according to predetermined selection or acceptance criteria.

A further aspect of the invention relates to a consolidated rideshare system for selective negotiated participation of riders, drivers and vehicles, said system comprising:

an internet server coupled to a global communications network;

a computer program product adapted to be loaded into said internet server; said program including a program code for establishing a first population of rideshare vehicles, a second associated population of drivers of said rideshare vehicles, and a third population of candidate passengers for said rideshare vehicles, constructing relationship databases for each of said first, second and third populations, providing a global internet portal for accessing said relationship databases according to predetermined restrictive access criteria and generating an output of potential matches of specific riders, drivers and vehicles according to predetermined correlation criteria thus enabling interactive bargaining between riders and drivers for said potential matches, and verifying a bargained match according to predetermined selection or acceptance criteria.

In yet another aspect, the invention relates to a computer program product adapted for loading into at least one memory of a computer readable tangible medium or into an electronic data processing apparatus, the computer program comprising program code for performing the establishment of a first population of rideshare vehicles, a second associated population of drivers of said rideshare vehicles, and a third population of candidate passengers for said rideshare vehicles and constructing relationship databases for each of said first, second and third populations while providing access to said relationship databases according to predetermined restrictive access criteria, said program code being further capable of generating an output of potential matches of specific riders, drivers and vehicles according to said predetermined correlation criteria to enable interactive bargaining between riders and drivers for said potential matches, and then verifying a bargained match according to said predetermined selection or acceptance criteria.

Additional features, embodiments and implementations of the invention will be more fully appreciated with respect to the following disclosure and appended claims.

### BRIEF DESCRIPTION OF THE DRAWINGS

FIG. 1 depicts a high level schematic representation of sequential communication between users and system. Users, either potential riders or potential ride providers, utilize User Communications Elements, which are typically cell phones, personal computers or other similar devices. Rider requests, systems response and confirmation data are passed between the system infrastructure and the User Communication elements.

FIG. 2 depicts a system schematic showing multiple users in communication with the system infrastructure at the same time, hence in automated negotiation with one another.

FIG. 3 depicts a schematic and textual representation of a user query format, which is used by the system as a means for data input of ridesharing attributes for users.

FIG. 4 depicts a schematic and textual representation of users grouped together based on compatible travel data following the initial processing by the ride negotiation system.

FIG. 5 depicts a schematic representation of the system of the invention, which illustrates the four types of data processing functions that are performed by the system of the subject invention.

FIG. 6 depicts a schematic representation of an embodiment of the rideshare negotiating system that is capable of communication with external on-line databases in order to expand the pool of users.

FIG. 7 depicts a schematic representation of an embodiment of the rideshare negotiating system that is in communication with external on-line databases for risk reduction and in order to improve the quality of a negotiated rideshare arrangement.

### DETAILED DESCRIPTION OF THE INVENTION, AND PREFERRED EMBODIMENTS THEREOF

There may be a variety of specific implementations of this invention, each of which will include combinations, i.e., some or all of the following sub-system elements:

Matching the Rider with a Ride Provider

There are four elements required for a successful rider-ride provider match: 1) acceptably similar routes, 2) adequately compatible personalities, 3) a means for the rider and ride provider to be notified, and 4) a way for the participants to verify each other's identify when they meet.
1. A sub-system for identifying ride providers and riders whose travel routes and schedules are similar, i.e. Travel Compatibility.
   a. The travel routes/schedules of prospective riders and ride providers that have been previously cataloged as registration information.
   b. Actual geographic coordinates history created using GPS or wireless technology, the latter including but not limited to mobile phone cell location, local Area network, wireless toll-road payment schemes, or internet device communications.
   c. The system may create a characteristic “image” of prospective riders' and ride providers' routes/schedules, based on numerical processing geographic histories (as in b.), combined with the cataloged routes and schedules (as in a.).
2. A sub-system for identifying compatible riders and ride providers, i.e. Personal Compatibility. Data for prospective riders is input into the system simultaneously or at two different times. In the later case, more permanent data is entered into the system at the time of initial user registration, and more updated information is submitted at the time of a specific ride sharing request query. Compatibility may be based a variety of factors such as those outlined below, including social networking databases, on mutual friends or friends of friends, acquaintances or coworkers, socioeconomic status, or on combinations of those or other like factors.
   a. User-provided personal data
      i. Group affiliations
         1. Religious
         2. Political party membership
         3. Professional
         4. Alumni
         5. National, regional, civic community, neighborhood
         6. Ethnic group
         7. Other groups, e.g. Boy Scouts, Knights of Columbus, etc.
      ii. Personal characteristics and common lifestyle attributes
         1. Interests such as games, favorite TV shows, music, vacation destinations, favorite books
         2. Age, sex
         3. Sex, marital status, sexual orientation
         4. Humor discriminators
         5. Support of political candidates, social reform, specific legislation
         6. Neighborhood
         7. Formal or informal discussion groups
      iii. Common sets of friends
         1. As part of a social network that is defined within a separate database
         2. Entered individually
      iv. Combinations of these factors, with the number of factors and selection priority able to be selected by the prospective rider, ride provider or group subscriber.
   b. Personal data that is not user provided, but user authorized
      i. Credit rating
      ii. Prison arrest record
      iii. SAT scores
      iv. Employment history
3. A sub-system for notifying proposed riders and ride providers that the system has identified (as above)
4. A sub-system for proposed riders and ride providers to review and select from the proposed ride counterparts, either individually or as part of a group of candidates.
5. A sub-system for authenticating the identities of said rider and ride provider combinations.
   a. Private password query and acknowledgement (either 1-way or 2-way)
      i. Person-to-person
      ii. Wireless, with or without personal intervention
   b. Publicly or privately issued ID card
   c. Use of one time password, “Signature” IC protected cards, or other personal authenticating devices
   d. Biometric features confirmation
      i. Voice recognition
      ii. Image recognition
      iii. Other types such as Iris scan, etc.

### Compensation Negotiation

Although a ridesharing system may be entirely operable using only the Matching attributes (1-5 above), the system also provides optional features for determining some form of compensation (monetary or non-monetary) in exchange for the services provided.
6. A sub-system for negotiating or auctioning to establishing a payment exchange rate between ride providers and riders.
   a. Type of value exchange i.e. qualitative aspects
      i. Monetary
         1. Debit or credit, includes internet payment schemes, e.g. PayPal
         2. Choice of currency
         3. tax credits
         4. co-payment of community obligations, such as taxes, etc
      ii. Non-monetary
         1. carbon credits
         2. fuel rationing credits
         3. philanthropic donations
         4. publicity
         5. membership in formal or informal social networks, structures or associations
         6. etc.
   b. Quantitative determination of “payment”
      i. Fixed or adjustable payment per mile or other metrics, pre-established by system subscription plan
      ii. Sliding scale based on fuel and fixed (capital costs that are borne by the ride provider.
      iii. Auction
      iv. Negotiated group plans
      v. Payment adjusted during the ride, at time of ride completion, or subsequently, based on ride and compatibility “quality of experience”
7. A sub-system for data and/or value exchange between riders, rider providers and centralized agencies (either public or private), which administer fuel rationing schemes, carbon-emissions credits, mileage per person averaging, joint commutation rewards, or any such other collective travel infrastructure management systems.

### Optimization of Matching Criteria & Ridesharing Compensation Terms

Although the system may be entirely operable using only the Matching attributes (1-5 above), or using the Matching attributes combined with some or all of the Compensation attributes (6-7 above), additional benefits may be had by utilizing several Optimization attributes.
8. A sub-system that tracks the degree-of-success history of past ride sharing experiences, and which uses that data to modify the future use and weighting of Matching criteria & Ridesharing Compensation terms, in order to increase the degree-of-success of the future ride sharing experiences.
   a. Determination and reporting of “Degree of success”
      i. Direct “per-ride” feedback of rider, ride provider
      ii. Tracking repeat rides, i.e. the same rider and ride provider
      iii. Indirect feedback that includes incidences of ongoing rider-ride provider relationships (which originated from contact via the subject system), including interaction in other social networks, such as: Facebook, Myspace, etc.
   b. Rating the specific rider/ride provider (e.g. as in eBay transactions)
   c. Combinations of a and b
   d. Optimization techniques
      i. Global optimization, etc.
9. A sub-system that allows subscribing individuals or groups to utilize the so-described ridesharing infrastructure (system and capabilities, including optimization), to explore and implement uniquely or broadly beneficial ways to further refine the so-described Ridesharing system environment for their particular application and constituency.

The utility and advantages of some or all of the possible combinations of these nine sub-systems may be variously exploited in specific implementations of the invention.

The invention in another aspect relates to a method for participants, both potential riders and ride providers, to prioritize (i.e., rank) their target attributes for the ride to be shared. The prioritizing of various complementary ride attributes can be used to match them with prospective other participants, involving optimization of short-term ride matching, or for optimization over a longer term of specific groups and associations of participants, in order to improve the likelihood of successful ride expense management, efficiency and social interactive experiences.

More specifically, this aspect of the invention relates to a ridesharing system involving selective negotiated participation of riders, drivers and vehicles, the system comprising a computer-implemented capability for computational matching of potential participants in a ridesharing arrangement, wherein the system is adapted for prioritized ranking of target ridesharing attributes by such potential participants, involving allocation by potential participants of quantitative weight within a quantitative total budget of allocatable value to predetermined selection criteria, with the system having an input capability for inputting said allocations of potential participants, and the system being constructed and arranged for effecting said computational matching based on the allocations, and the system including communication capability for outputting results of the computational matching to the potential participants.

Such ridesharing system may be implemented to comprise an internet server coupled to a global communications network, and a computer program product adapted to be loaded into such internet server to process the inputted allocations, effect the computational matching based on said allocations, and outputting results of the computational matching to the potential participants.

As hereafter discussed in greater detail, the predetermined selection criteria may comprise one or more of: quality of a ride experience; speed, ease and/or efficiency of getting to a destination; compatibility of ridesharing participants; and quantitative value exchange involved in a ridesharing transaction. The predetermined selection criteria regarding quality of ride experience are also referred to subsequently in this application as feedback values. The criteria relating to speed and/or efficiency of getting to a destination are also used interchangeably with time values. The selection criteria regarding the compatibility of the ridesharing participants are referred to in subsequently described embodiments as quality values, and the quantitative value exchange attributes are also known as compensation values.

In such system, the quantitative total budget of allocatable value may constitute a total ride satisfaction budget of a predetermined number of units, which may be the same for all potential participants.

In specific implementations, the ridesharing system may be programmatically arranged to effect a best matching approach to available selectees of the system for the ridesharing arrangement from among said potential participants, and in a further aspect, the system may include capability for alternative public or private identity descriptors selectable by a potential participant. A detailed example of how the data processing function of the system could be programmed to effect such a best matching approach from among a pool of potential participants is set out below.

One essential characteristic of the aforementioned system implementation of the invention is the opportunity for trade-off that a participant may consider between three primary independent ways of valuing the ridesharing transaction and experience. These independent elements, or ride satisfaction determinants, may be described as
1. the quality of the ride experience, as considered independently (and not as a combination of elements 1 and 2)—this experiential quality may for example involve such factors as compatibility of the ridesharing participants, their common interests, subsequent social interactions, business dealings and/or ride relationships;
2. the speed, ease and/or efficiency of getting to a destination,
3. the quantitative value exchange involved in the ridesharing transaction (e.g., payment, credit/debit exchange, barter of goods/services, etc.)

For the potential ride provider, these three independent attributes can be simplified to “good”, “fast” and “cheap”, for the purposes of this discussion.

These three independent attributes of good, fast and cheap are typically traded against each other in a majority of commercial purchasing transactions of any kind, and a ridesharing system that explicitly allows the users to assign weights to them enables the ridesharing system to be more easily and widely used, and lends itself to optimization to improve the success of the typical ridesharing experience that is arranged using the system. This scheme has the purpose and effect of encouraging a more widespread adoption of ridesharing systems.

As an illustrative example, a potential rider (who wants to identify a ride provider) will submit a two-part request to the ridesharing system. The first part will contain the rider's identity and the details of the ride that is desired to be arranged. The second part will contain the rider's ranked preferences for the good, fast and cheap attributes. Since this choice involves a trade-off, a greater desire for a “good” ride will need to be compensated by reduced expectations for a cheap ride and/or a fast ride.

For example, a potential rider may be granted, in a hypothetical system implementation, a total ride satisfaction “budget” of 100 units. That person may choose to request a specific ride start and end location on a certain date, with:

ride quality assigned an importance of 25 units,

ride speed assigned an importance of 10 units, and

ride cost being assigned an importance of 65 units.

Under these attribute selection criteria, the system then conducts a corresponding search for a ride provider with the predominant attribute of lower cost, and with a significantly lower importance given to ride quality (e.g. social compatibility, membership in similar social networks, etc.). In this case the importance of the ride speed attribute has a quite low assigned value. If these criteria are to be satisfied reasonably specifically in regard to the selection criteria, it may take a relatively long time for such a ride to be realized, based on both the system's time requirement to identify the ride compatible with the selection criteria, and the time involved in vehicular travel to reach the destination. The system may therefore be programmatically arranged to effect a “best matching” approach to available selectees of the system for the ridesharing arrangement.

Of course other weightings of criteria can be selected as predetermined attributes for the matching process, depending on the potential user's preferences.

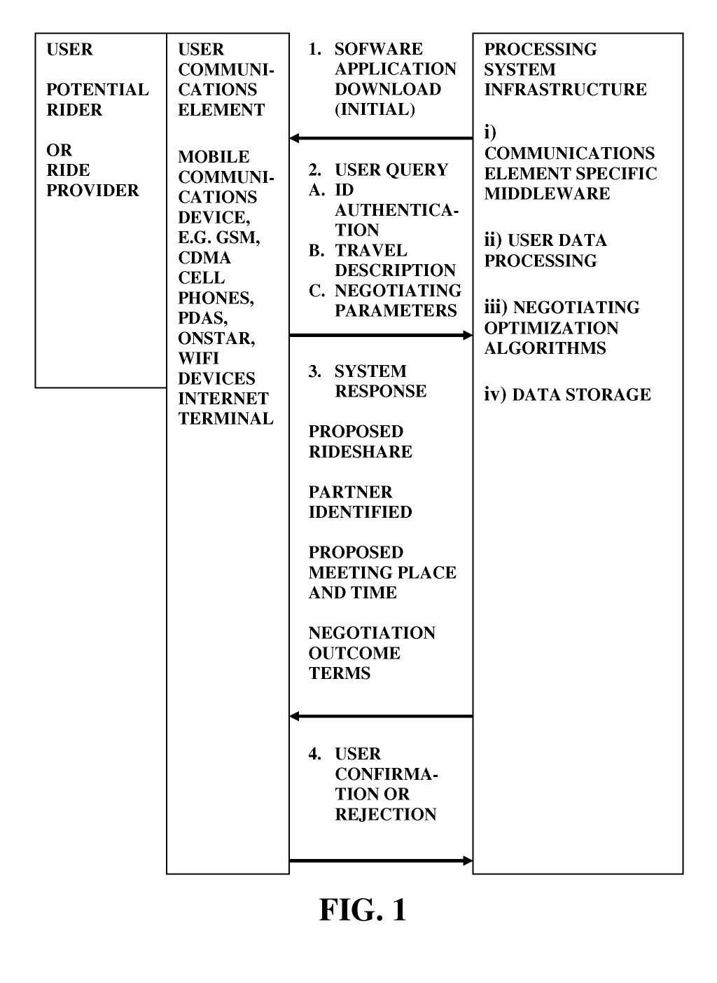

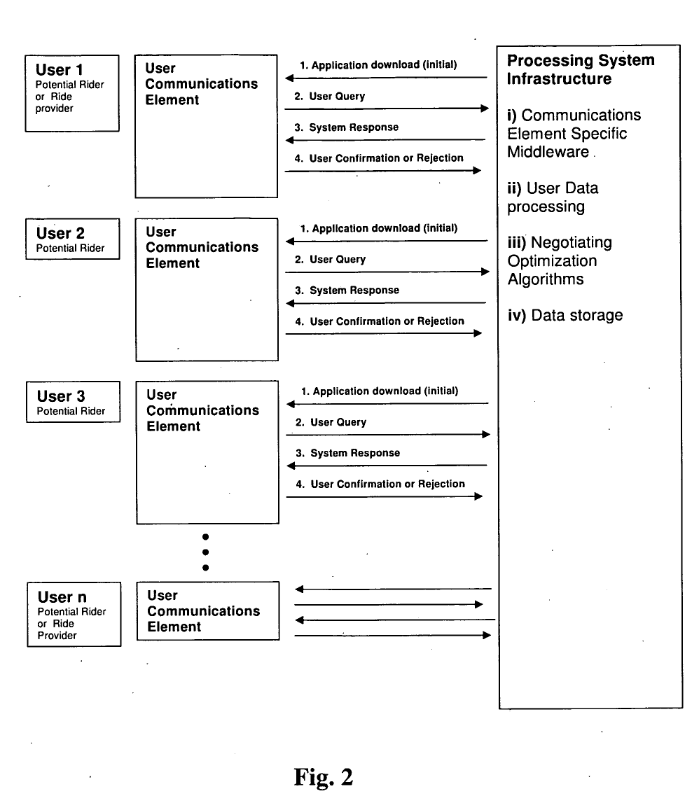

In another illustrative embodiment, the ride sharing system is a comprehensive system where all users utilizing the system negotiate with other co-subscribers within the system. This type of unified negotiated ride sharing system is schematically represented by FIG. 1 and FIG. 2.

In the system depicted in FIG. 1, users may be potential ride providers or potential riders, who communicate with the system via user communication elements. A user communication element is defined as any device such as an internet connected personal computer, wireless internet device, cell phone, or any other suitable device capable of connecting to the internet. Other suitable devices include personal digital assistants (PDAs, e.g., Blackberries™) or dedicated vehicular communications systems (e.g., On-Star™) via all known and various communication protocols. The user communication elements may use all known methods to communicate with the system via the internet, including hardwired communication or wireless communication, such as Wi-Fi. Alternatively the user communication element may jointly or partly use a local area network or other such network to connect to the system. Cellular phone transmissions are a preferred method of communication between the user communication element and the system due to the mobility and widespread use of cellular devices, and also due to the specificity of such devices, i.e. each cell phone has a unique number and is usually linked to a single identifiable user. In the embodiment depicted in FIG. 1, a user may use a cell phone as a user communication element to communicate with the system via the internet connectivity of the cellular device, or via the text message or voice communication capability of the cellular device.

FIG. 1 schematically illustrates the various phases of communication of an embodiment of a unified system, including the initialization 1 of the user communication element via download of system application software to the user communication element. Subsequent phases of communications between the user and the system, depicted in FIG. 1 as items 2-4, constitute further routine communications between the user and system in order to facilitate collection of the necessary data to facilitate the negotiation for the shared ride arrangement between a rider and a ride provider.

Item 1 of FIG. 1 depicts the initial communication phase in which a new user signs up with the system providing the typical personal/financial identification and authentication that is typical for the mediation of financial transactions. At this initial registration, a fee may be paid by the new user in the form of a monetary deposit provided electronically, such as a credit card or bank account number authorization or any other type of verifiable electronic funds transfer. Once the initial fee payment is complete, specialized software applications are downloaded via the internet or via the cell phone service provider that allow the user communications element to be used in conjunction with the rideshare negotiation system. The software applications may reside in the memory of the cell phone itself or alternatively in the cell phone service provider's internal network.

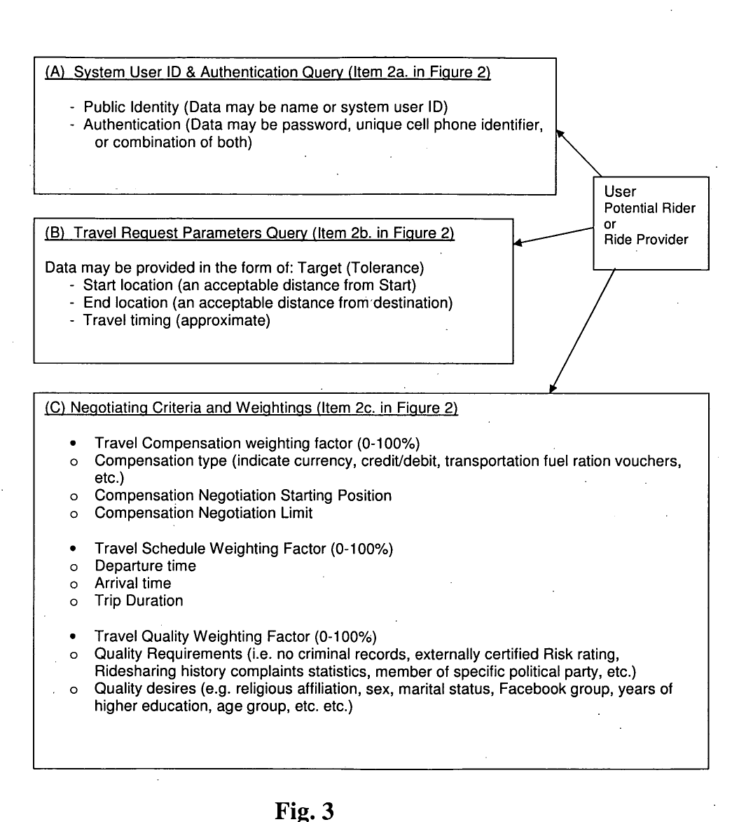

Item 2 in FIG. 1 depicts the subsequent communications phase, the user query, during which the system queries the user for identifying, logistic and negotiating parameters that are used by the system for computational matching of the users in a ridesharing arrangement. An example of the data content collected in the user query and a potential user query format are depicted schematically and textually in FIG. 3. Items A, B, and C, depicted in FIG. 3 identify the various data elements used by the various sub-systems of the negotiated ride system to match the riders and ride providers and optimize those matches. Items A and B of the user query shown in FIG. 3 comprise the A identification/authentication data and B travel parameters. System implementations will typically incorporate both the ID/authentication and travel parameters, since these data elements are necessary to match a rider with a ride provider. Item C of the user query depicted in FIG. 3 lists the independent negotiating criteria and a weighting scale (0-100%) representing the relative importance of those factors to the user in the travel negotiation. The independent negotiating criteria may vary in different system implementations. In this example, the negotiation criteria are comprised of three groups: travel compensation, travel timing and travel quality. Within those groups of compatible travel requests, grouped by location and approximate timing, the system data processors will numerically search for rider-ride provider matches according to the query negotiating parameters (∘) and weighting factors (•). Note that the various data elements used by the various sub-systems of the negotiated ride system as shown in the user query format example in FIG. 3 are also constituents 2a, 2b, and 2c shown in the user query in the overall schematic representation of the system shown in FIG. 1.

Item 2a in FIG. 1, which depicts the queries of the user for identification/authentication, is a sub-system that is also capable of simply validating the user's identity based on a system registry containing the user communication element, utilizing a unique identifier for that user, such as the cell phone's number or a personal computer's internet address. Item 2b in FIG. 1, also included in the user query, contains the travel request parameters, which describe the shared trip through the input of various geographical essentials, such as the start location, ending location, and approximate trip duration. These variables are general non-negotiable attributes, required to identify the potential trip. The user query also includes the negotiating criteria and weightings, item 2c in FIG. 1, which embodies one of the innovations of the subject invention, the capability to negotiate the best ride possible in terms of qualitatively different criteria, e.g. the quality of the ride experience, the cost of the ride, and the speed of potential ride. Note that the negotiating criteria used in this example are not limiting in any way, and other criteria, as well as more or less criteria could be used. The subsequent communications between the system and the user are also depicted in FIG. 1, by items 3 and 4. Item 3 depicts the system response, which is a proposed ridesharing arrangement sent to the user by the system following processing of the user query, while item 4 of FIG. 1 depicts the user response confirming or rejecting the proposed ridesharing arrangement.

Finally, the overall schematic and textual representation of the negotiated ride system in FIG. 1 also depicts a schematic representation of the processing system infrastructure. In one aspect, the processing system infrastructure includes i) one or many diverse external communications portals as needed to communicate with the user communication elements, ii) data pre-processing hardware loaded with system software to categorize and convert the user queries into standard data processing parameters, iii) a primary processing “computer”, which may be a single processor or a networked group of parallel processors, and iv) a medium with data storage capability, which similarly may be centralized in a single location or distributed in various locations. The arrangement of this type of processing system is familiar to those of ordinary skill in the art and is not limiting of the computational processes and storage requirements necessary for the ridesharing system. The necessary functions may be accomplished by any capable system configuration or arrangement. FIG. 2 depicts a schematic representation of multiple users in communication with the system at the same time. As depicted in FIG. 2, the system is capable of simultaneously handling multiple communications to facilitate the optimal matching of rider and ride provider.

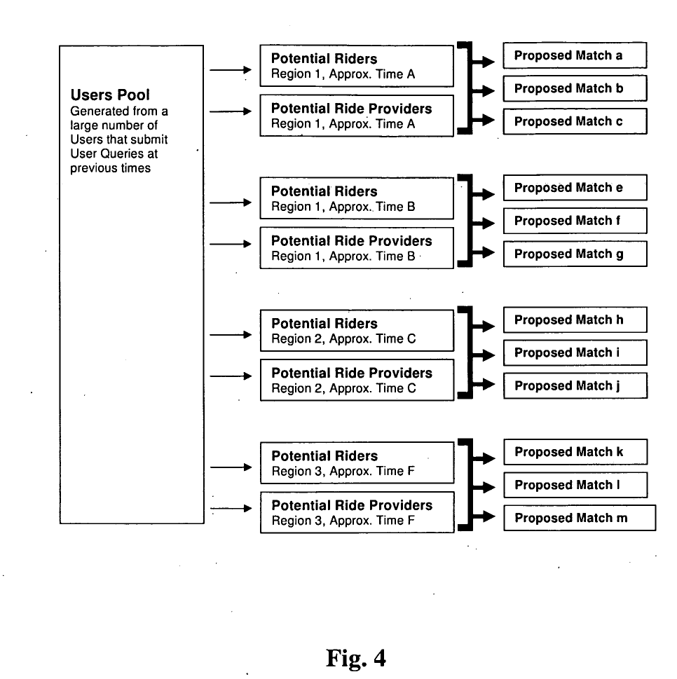

As stated above, two of the key aspects to the optimal matching of rider to ride provider are the identification of acceptably similar routes and the matching of adequately compatible personalities. The system accomplishes these tasks through a unique processing system. One aspect of the processing system is depicted schematically in FIG. 4, which illustrates how the users are categorized into complementary “bins,” with each pair corresponding to potential riders and potential rider providers that could be compatible in terms of travel logistics, i.e. the travel data for time and destination are very close or in fact match. As used in this application, a “bin” is a discrete data structure or any electronically readable data structure, capable of storage and retrieval of multiple assigned values. In this aspect of the invention, after the system has processed all of the possible complementary pairings, the user's negotiating criteria and the relative weight assigned to each negotiating criteria are then processed by the system, in order to identify and propose the specific optimal matching ridesharing arrangements. Thus, when multiple user queries are received by the processing system infrastructure, as depicted schematically in FIG. 2, the system categorizes and sorts the user queries into “bins” with other user queries that are similar for a particular geographic locale and time window, as depicted schematically in FIG. 4.

The result data structure is a number of complementary bins with a number of potential ride providers, potential riders, and potential matches. The processing system then computationally sorts for the optimal fit between potential riders and potential ride providers in complementary bins based on the correlation of the negotiation targets, in order to generate proposed matches to the potential rideshare partners. As depicted in FIG. 2, as the network of users grows larger and the system proliferates, large numbers of potential ride providers and potential riders will populate the complementary bins, thereby enabling a robust negotiating environment and a reasonably high degree of satisfaction in the users' populations.

Note that matching the compensation objectives of the potential rideshare partners is facilitated by the use of multiple negotiation targets, as explained by the following illustrative example.

After first sorting by locale and travel parameters, a pair of complementary bins may represent riders and ride providers that will be traveling approximately clockwise on Rt. 128 in Boston on the afternoon of August 8th. For this illustration, assume the negotiated values for consideration are the compensation starting position and the compensation limit. A potential ride provider may offer transportation between Reading and Marlboro, with a compensation starting position of $0.20/mile, and a compensation limit of $0.12/mile. In the complementary bin, a potential rider may have a compensation starting position of $0.10/mile, and a compensation limit of $0.18/mile. Since the compensation limit ranges overlap, both could be compatible, and the compensation value that the system proposes would reflect this compatibility. Note, however, that the negotiated value proposed by the system may vary depending on other non-monetary items, most generally pertaining to travel quality criteria, e.g. political affiliations, club memberships, etc., and to travel schedule parameters, i.e. how much leeway the rider has in his or her arrival time.

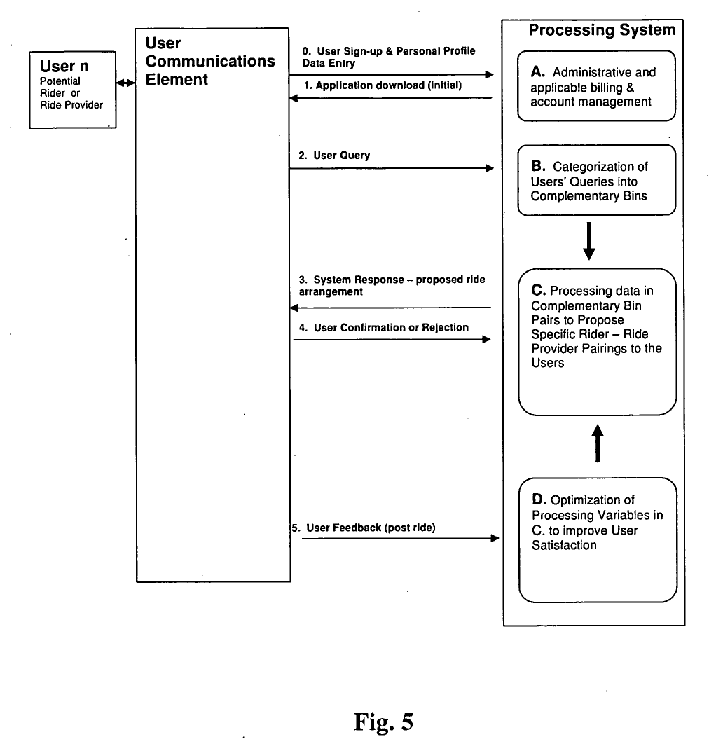

The schematic representation of the system in FIG. 5 depicts item C, which is the data processing function of the system that processes the negotiated value data in the complementary bin pairs to match the objectives of the potential rideshare partners. This function is a critical aspect of the negotiated rideshare system, which performs four types of data processing functions as illustrated in FIG. 5 and described in detail as follows.

FIG. 5 depicts a schematic representation of the processing system of the negotiated rideshare system that illustrates the four types of data processing functions A, B, C, D that are performed by the system.

The administration and account management function A of one embodiment of the rideshare system as shown in FIG. 5 handles users interactions with the rideshare system that are not related to specific ride requests or feedback. This function handles all data processing relating to initial subscription with the system, payment arrangements, customer service, cancellation of the service, etc. This sub-system also records and handles personal information introduced by the user query, such as age, political affiliation, hobbies, ethnic background and other similar data. This sub-system also includes authorization for the system to contact external personal information databases, pre-set profiles for either ride negotiating or ride quality requirements, and make other similar external database communications.

The data processing function B of the embodiment of the rideshare system as depicted in FIG. 5 handles receipt of users' queries and categorization of the users into complementary bins based on the travel data elements.

Users' queries are received, assigned a unique number, as well as a tracking code corresponding to that user, and placed in complementary bin pairs as previously discussed, based on the identification of acceptably similar routes. Each pair corresponds to potential riders and potential ride providers for a specific location criteria and travel time window. The bin assignments are determined from data and variables such as is set out in Table 1 below. It is self evident that the larger numbers of user queries received by the system, the breadth of the geographic and travel time range in a complementary bin pair may be narrower, thus increasing the likelihood of finding a suitable match.

Table 1 is an example of a set of travel request parameter variables, such that would be provided in each user query, which the processing system uses to categorize the user queries into complementary bin pairs corresponding to similar geographic and timing travel requirements.

TABLE 1

| | | Variable | |
|---|---|---|---|
| Variable Name | Symbol | Type | Variable Units |
| Start Location | S | Numeric | Latitude. & Longitude |
| Start Location Tolerance | ST | Numeric | Kilometers |
| End Location | E | Numeric | Latitude. & Longitude |
| End Location Tolerance | ET | Numeric | Kilometers |
| Travel Arrival Time | A | Numeric | Greenwich Mean Time |
| Travel Arrival Tolerance | AT | Numeric | Minutes |

The data processing function C of the embodiment of the rideshare system as depicted in FIG. 5 handles processing the data in complementary bins to identify and propose rider-ride provider matches. This data processing function comprises a key aspect of the decision making of the rideshare system. For each complementary bin pairing, there are a variety of users' queries that are computationally searched for suitable matches. For each user query submitted by a potential ride provider in that bin pair, the multitude of user queries from potential riders are correlated and processed to yield viable ridesharing arrangements. In performing the computational matching of users based on the data from the user queries, there are a large number of computational variables that may influence the matches generated and proposed to users.

Table 2 sets out an example set of possible variables for negotiating criteria and weighting of compensation, quality, and time values. The three attributes that are covered by the example set of variables of Table 2 are the “good”, “fast” and “cheap” attributes that were described earlier by this application. For each of these attributes a quantitative weight within a quantitative total budget of allocatable value (0-100%) is also assigned by the user, depending on the relative importance to the user of that attribute. All variables are provided for each user query, which the processing system operates and processes to identify and propose possible ride matching arrangements.

TABLE 2

| | | Variable | |
|---|---|---|---|
| Variable Name | Symbol | Type | Variable Units |
| Compensation | CW | Numeric | % |
| Weighting | | | |
| Compensation Type | CT | Logical | — |
| Negotiation Start | NS | Numeric | $/mile |
| Negotiation Limit | NL | Numeric | $/mile |
| Schedule Weighting | SW | Numeric | % |
| Arrival Time | NAT | Numeric | GMT |
| Trip Duration | NTD | Numeric | Minutes |
| Quality Weighting | QW | Numeric | % |
| Quality Requirement 1 | QR1 | Logical | Pre-set menu |
| Quality Requirement 2 | QR2 | Logical | Pre-set menu |
| Quality Requirement 3 | QR3 | Logical | Pre-set menu |
| Quality Preference 1 | QP1 | Logical | Pre-set menu |
| Quality Preference 2 | QP2 | Logical | Pre-set menu |
| Quality Preference 3 | QP3 | Logical | Pre-set menu |

Within each complementary bin pair, the user queries for the potential riders may be expressed in a variable form as U_{R1}, U_{R2} . . . U_{RX}, with one variable for each potential rider (user/rider), and U_{P1}, U_{P2} . . . U_{PY} for the potential ride providers (user/providers), with also one variable per ride provider. For each combination of potential rider and potential ride provider, a matching rank value R_{RiPj} may be calculated by the operator F, for the variables such as those set out in Table 2. This equation may be expressed as R_{RiPj}=F(U_{Ri}, U_{Pj}) where i and j may take the values of 1 through X and 1 through Y, respectively.

For each pair of user queries from the complementary bin pair, the operator F uses the data in those queries to determine whether a match is possible and is likely to result in a satisfactory ride experience. The ridesharing system in this manner uniquely contemplates a wide range of qualitatively different types of “travel desires” that could be input via the user queries. As an illustrative example, the data variables as set out in Table 2 are comprised of compensation negotiating terms, schedule/time terms and quality terms. These variables assign discrete values to the “good”, “fast” and “cheap” attributes that are typically traded against each other in commercial purchasing transactions. Thus the operator F has component parts F_{N}, F_{S} and F_{Q} that in this case operate on each pair of negotiation terms, schedule terms and quality terms, respectively. This equation may be expressed as F[F_{N}, F_{S} and F_{Q}]. As seen in Table 2, the variables values for negotiation terms, schedule terms and quality terms are typically of different type, i.e. numeric or logical, and therefore the operator F may depend on F_{N}, F_{S} and F_{Q} in a wide variety of ways.

In this embodiment of the system, each of these component operators F_{N}, F_{S} and F_{Q} operates on a unique subset of the variables as set out in Table 2. Thus the negotiation terms operator F_{N} may, for each potential rider-potential ride provider pair U_{Ri}, U_{Pj}, numerically evaluate those users queries negotiating start and negotiating limit positions, in order to define mutually agreeable compensation terms according to the following equation: F_{N}(U_{Ri}, U_{Pj})=F_{N} (CW_{Ri}, CW_{Pj}, NS_{Ri}, NS_{Pj}, NL_{Ri}, NL_{Pj}). In this embodiment, since the data values are numeric, the operator equation uses numeric data and arithmetic calculations. The analogous equations for the schedule and quality criteria would be: F_{S}(U_{Ri}, U_{Pj})=F_{S} (SW_{Ri}, SW_{Ri}, NAT_{Ri}, NAT_{Pj}, NTD_{Ri}, NTD_{Pj}) and F_{Q}(U_{Ri}, U_{Pj})=F_{Q}(QW_{Ri}, QW_{Ri}, QR1_{Ri}, QR1_{Pj}, QR2_{Ri}, QR2_{Pj}, QR3_{Ri}, QR3_{Pj}, QP1_{Ri}, QP1_{Pj}, QP2_{Ri}, QP2_{Pj}, QP3_{Ri}, QP3_{Pj}, PD_{Ri}, PD_{Pj}).

In these equations for evaluating users' queries for schedule and quality terms, F_{S} and F_{Q} are also calculated from logical operations on the variables' values that are provided in the user queries, as well as the values from the personal data that is supplied at the time of initial subscription to the system. The personal data, which may be an extensive set of values, are used in one embodiment in the F_{Q} operations, and are given the variable name PD in the above equation.

In an illustrative system implementation, the quality requirements variables (e.g. QR1) may need to match exactly, for example one QR1 for one user query may seek a ridesharing partner in the 25-34 year old age group. Failure to match exactly would effectively eliminate those two users from sharing a ride. On the other hand, quality preferences variables (e.g. QP1) may be evaluated on a relative scale, as opposed to an absolute scale as with the quality requirements variables, thus permitting the proximity of one user's attributes to another's to facilitate a ride sharing match. One example of a quality preference would be a user's input that the rideshare partner be registered in the Democratic Party. In some cases those registered as Unaffiliated may still be deemed as acceptable.

Note too that each of the variable areas such as the negotiation terms, schedule, terms and quality terms has a weighting variable included, designated CW, SW and QW. These components of the user query are used by the component operators to determine the importance and hence the numerical weight of the three parts of the negotiating criteria: compensation terms, schedule and quality. For example, user query U_{R493} may place only “5% importance” on compensation terms; the system could therefore assign CW_{R493} a value of 5%. This may result in a proposed ride match that is far from the compensation targets of this user query, but which might result in a much better fit for arrival time and/or the quality attributes of the ride sharing experience.

Depending on the number of queries in a complementary bin pair and the nature of the user queries, there may be no potential matches identified, for example see Table 3 below for variable U_{R3}, or there may be one, see Table 3 for U_{R1}, or there may be many, see Table 3 for U_{R2}. If there is more than one potential match, a hierarchy based on the matching rank R is established by the system, and the proposed matches are transmitted to the applicable users via their user communication elements.

As an illustrative example, if a hypothetical complementary bin pair contains 3 user queries for potential riders, and 3 user queries for potential ride providers, the nine resulting combinations for these 6 user queries may be assigned the ranks as set out in Table 3 below. In this example, the higher values of R indicate that the system processed certain combinations to be more likely to result in a favorable ridesharing experience based on the comparison of the criteria and the calculations of the rideshare system as explained above. The values of 0.00 indicate that the combination of that pair of user queries will not result in a proposed ridesharing. As displayed by the values of Table 3, the user that submitted user query U_{R1} has only one choice, that of the ride provider described by U_{P3}. The user who requested a ride using query U_{R2} meanwhile has three choices, with the ride provider described by user query U_{P1} having the highest rank, 19.24. In this example, following the transmission of the proposed matches to the users, the system awaits the responses from both the applicable potential riders and the applicable potential ride providers. If the complementary proposals sent to potential ride providers and to potential riders are accepted, the system provides an affirmation code to those users, as well as information on when and where to meet.

Examples of matched rank values R_{RiPj} that are generated by Operator F, for user queries from three potential riders and three potential rider providers.

TABLE 3

| | User Queries - | |
|---|---|---|
| User Queries - | Potential Ride | |
| Potential Riders | Providers | R_{RiPj} |
| U_{R1} | U_{P1} | 0.00 |
| U_{R1} | U_{P2} | 0.00 |
| U_{R1} | U_{P3} | 6.28 |
| U_{R2} | U_{P1} | 19.24 |
| U_{R2} | U_{P2} | 1.62 |
| U_{R2} | U_{P3} | 8.31 |
| U_{R3} | U_{P1} | 0.00 |
| U_{R3} | U_{P2} | 0.00 |
| U_{R3} | U_{P3} | 0.00 |

The data processing function D of the embodiment of the rideshare system as depicted in FIG. 5 handles the optimization of the processing variables to improve customer satisfaction through feedback variables. The capability of the processing system of the subject invention to modify the operator F based on feedback from users via a data processing sub-system is a novel capability, which allows for improved customer satisfaction through the unique feedback system.

Table 4 is an example set of variables that are provided by the users following a shared ride for utilization by the system for optimization.

TABLE 4

| | | Variable | |
|---|---|---|---|
| Variable Name | Symbol | Type | Variable Units |
| Ride Experience | REF | Numeric | no units |
| Feedback | | | |
| Ride Provider Feedback | RP | Numeric | no units |
| Rider Feedback | RF | Numeric | no units |
| Rider Comments | RFC | Logical | Pre-assigned options |
| Ride Provider Comments | RC | Logical | Pre-assigned options |

In addition to modifying the operator F to improve user satisfaction, there are other benefits from determining what relationships may exist between the data variables of the interdependent data sets. Optimization may lead to improvements in processing times, to minimize storage of large amounts of data, to potentially prevent catastrophic interactions between users who share rides, and other potential benefits.

In order to modify the operator F to improve user satisfaction, F (or equivalently its components F_{N}, F_{S} and F_{Q}) may be considered as function of a number of processing variables, such as in the equation F=F(α, β, γ, δ, . . . ω). These processing variables may include, for example, data set sample sizes, system internal weighing of specific user supplied parameters, statistical conditioning of certain datasets, etc. As is common practice in systems with large volumes of interdependent data, the relationship between certain dependent variables and other independent variables can be numerically determined using regression analysis or other methods. In general the variables indicating user satisfaction (i.e. REF, RP and RF) will have some unknown dependence on the processing variables α, β, γ, δ, . . . ω. If a systematic correlation is found between pairs of dependent variables and the processing variables, for example β and RP, the processing variable may be modified in a way to improve RP, which may be indicated by an increase in its numeric value. This optimization may lead to increased rider and ride provider satisfaction and generate positive feedback that is spread beyond the internal users to external users of the ridesharing system.

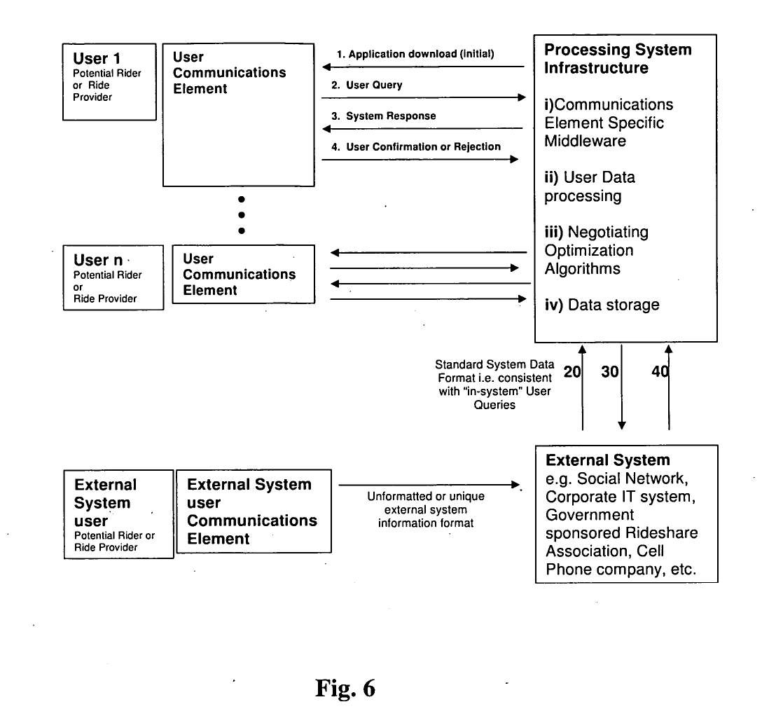

FIG. 6 depicts a schematic representation of a modified embodiment that uses the ridesharing negotiation system to communicate with other subscriber systems to increase the pool of the prospective ride providers and prospective riders. These external systems may or may not have ridesharing as their primary function, but communication with external systems is accomplished using standard communication and security protocols, and via the user query format as described in prior examples.

One illustrative example may involve a parcel delivery company, such as Federal Express, that has excess ridesharing capacity to expand the pool of potential ride providers. Once satisfying certain regulatory and insurance requirements and agreement with the operator of the ridesharing system, the parcel company would become an external user providing additional ride provider options to other users of the system. Riders matched with the parcel companies vehicles exchange payment in typical means such as via credit, debit, pre-paid cards, cash, etc. For delivering or picking up parcels each day, the parcel delivery company does not operate on pre set or pre scheduled routes, but instead utilizes a route that is computationally determined to minimize fuel expenses, traffic jams and distance traveled. Optionally the ridesharing negotiation systems of the subject invention provide an additional set of optimization input parameters on which the parcel company could plan a travel route.

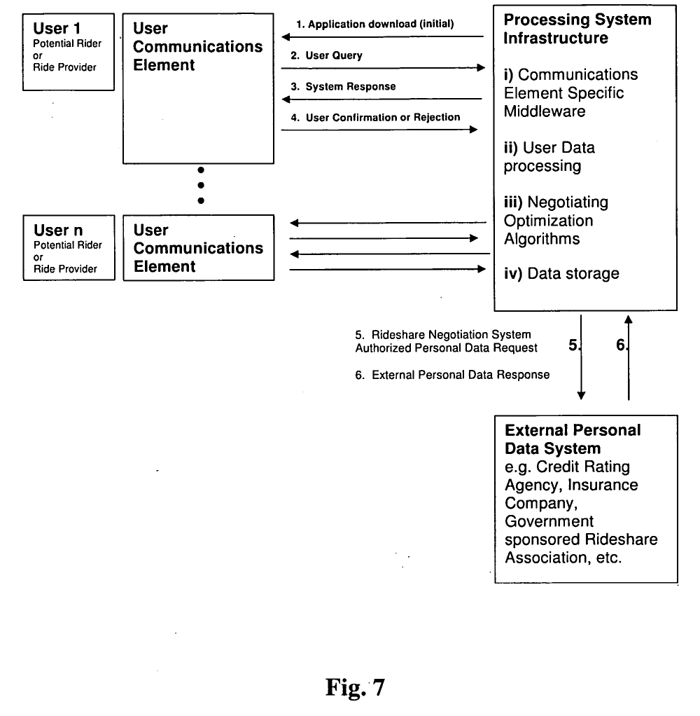

FIG. 7 depicts a schematic representation of another embodiment of the negotiated rideshare system, with the additional feature of permitting communication with outside systems or databases to add to information provided by the users, and/or to further characterize or substantiate the information provided by those prospective ride providers and prospective riders. In this embodiment of the system, in addition to the normal data queries, the administrative/account management data processing function additionally operates to keep track of user feedback on riders and ride providers, and this information is complemented by referral information from an outside data source.

As an illustrative example, in this embodiment during a user's initial sign up with the system, or as part of a user query, the subject ridesharing system is granted authorization for personal information from a separate database to be accessed by prospective users. The retrieved information is used to further characterize a potential rider or potential ride provider. Any type of external database that stores information about users with information to further categorize a rider and ride provider may be implemented with this embodiment. External databases with information such as those maintained by credit rating agencies, or an-on-line “personals” dating service, or a social networking site, are all capable of exchanging information with an embodiment on this invention. Use of an outside database to enhance personal information used in the negotiated ride matching function potentially creates better matches due to the increased number of variables used to correlate the rider and the ride provider.

It is contemplated in the practice of the present invention that the system may be arranged in specific implementations so that a system user has both public and private identity descriptors in the use of the system, which can both be used to optimally identify ride participants, either a potential rider or a ride provider. This permits the potential participant to stipulate which identity descriptors can be used at various times or in various circumstances. This public/private dual descriptor capability can also be used in application to specific groups, such as a social network, in respect of that group's identifiers, in seeking or offering cooperative ridesharing arrangements.

In another embodiment of such a system implementation, the system allows both the potential rider (ride seeker) and the potential ride provider to assign values to the weighted selection criteria for a particular search, or for a search associated with an ongoing series of rides. The weighted selection criteria may also be used by a group, for example a social network, to identify rides or riders for their members, with targeted characteristics involving “good”, “fast” and “cheap” attributes, which are also know as quality terms, schedule/time terms, and compensation negotiating terms. It is noted that when a potential ride provider also seeks to balance the three ride selection criteria listed above, the third criterion involving quantitative value exchange (also known as compensation negotiating terms) would not be simplified as “cheap”, but instead will be a quantitative remuneration criterion.

It will therefore be recognized that the invention is susceptible to implementation in a wide variety of specific arrangements, consistent with the disclosure herein, and the purpose of effectuating ridesharing as a cost-effective, efficient and socially beneficial activity.

The ridesharing system and method of the invention in one embodiment is constituted and arranged so that the computational matching comprises matching of a driver to at least one potential rider to minimize travel distance involving a series of destinations.

In another aspect, the computer program product of the invention may be constituted to comprise code enabling access to and communication with the relationship databases storing driver and potential rider information.

The ridesharing system and method in a further embodiment may be constituted and arranged so that a driver and the rider are involved in negotiated ridesharing participation independently of one another, utilizing separate subsystems or external systems adapted to communicate with one another via a predetermined ridesharing protocol.

In the ridesharing system and method according to yet another embodiment, one of the predetermined selection criteria is a qualitative or quantitative measure of risk provided by a third party through a database that is communicatively linked via the internet to an internet server running program code of the ridesharing system.

In a further aspect, the invention relates to a ridesharing system involving selective negotiated participation of riders, drivers and vehicles, said system comprising a computer-implemented capability for computational matching of potential participants in a ridesharing arrangement, wherein said system is adapted for prioritized ranking of target ridesharing attributes by such potential participants, involving communication by potential participants involving allocation by potential participants of quantitative weight within a quantitative total budget of allocatable value to predetermined selection criteria, with said system having an input capability for inputting said allocations of potential participants, with the inputted quantitative values computationally categorized by said system, and with the system being constructed and arranged for effecting said computational matching based on said allocations, and including communication capability for outputting results of said computational matching to said potential participants.

The ridesharing system and method may be constituted with a capability for estimating, and outputting to potential participants during ongoing computational matching, the time a driver must travel to reach a location of a potential rider.

The system and method in a further embodiment may be constituted and arranged to communicatively link potential participants during ongoing computational matching. The system and method alternatively, or additionally, may be constituted and arranged to collect and assimilate feedback from participants after completion of a ridesharing event, in which the feedback characterizes the ridesharing event qualitatively and/or quantitatively. The system and method can be constituted to utilize such assimilated feedback data to computationally modify algorithms for rider and ride provider matching, in order to improve likelihood of a favorable ridesharing experience in a future ridesharing computation matching.

It will be apparent that the ridesharing system and method may be constituted and arranged for operation in a wide variety of operational modalities. For example, the ridesharing system and method may be constituted and arranged to comprise at least one of the following characteristics:

(a) computational matching comprising use of multiple disparate matching criteria including quantitative matching criteria and qualitative matching criteria;
(b) computational matching comprising use of use of matching criteria including risk determination criteria;
(c) computational matching including user-generated weighting of disparate input criteria;
(d) ridesharing optimization in which user feedback is employed to modify computational matching algorithms to improve at least one of (i) user satisfaction, and (ii) system operational parameters selected from the group consisting of (A) computational time of said computational matching, and (B) system data storage requirements for said computational matching;
(e) use of the system, or elements thereof, with another system that acts to computationally determine an optimum vehicle travel plan including multiple stops and destinations.

For example, a system of the invention may be constructed and arranged to comprise characteristics (a), (b) and (c).

The disparate input criteria specified in (c) may in particular embodiments include the matching criteria of (a) and/or (b).

In another variation, a system of the invention may be constructed and arranged to comprise characteristic (d), e.g., wherein the matching algorithms are modified to improve user satisfaction and the system operational parameters (A) and (B).

Other variants of the system include those in which the system is constructed and arranged to comprise characteristic (e), and those in which the system is constructed and arranged to comprise all of the aforementioned characteristics (a)-(e).

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A ridesharing system involving selective negotiated participation of riders, drivers and vehicles, said system comprising a computer-implemented capability for computational matching of potential participants in a ridesharing arrangement, wherein said system is adapted for prioritized ranking of target ridesharing attributes by such potential participants, involving allocation by potential participants of quantitative weight within a quantitative total budget of allocatable value to predetermined selection criteria, with said system having an input capability for inputting said allocations of potential participants, and said system being constructed and arranged for effecting said computational matching based on said allocations, and the system including communication capability for outputting results of said computational matching to said potential participants.

2. A method of operating a consolidated rideshare system involving selective negotiated participation of riders, drivers and vehicles, said method comprising:
establishing a first population of rideshare vehicles, a second associated population of drivers of said rideshare vehicles, and a third population of candidate passengers for said rideshare vehicles;
constructing relationship databases for each of said first, second and third populations;
providing a global internet portal for accessing said relationship databases according to predetermined restrictive access criteria,
generating an output of potential matches of specific riders, drivers and vehicles according to predetermined correlation criteria,
enabling interactive bargaining between riders and drivers for said potential matches, and
verifying a bargained match according to predetermined selection or acceptance criteria.

3. A consolidated rideshare system for selective negotiated participation of riders, drivers and vehicles, said system comprising:
an internet server coupled to a global communications network;
a computer program product adapted to be loaded into said internet server; said program including a program code for establishing a first population of rideshare vehicles, a second associated population of drivers of said rideshare vehicles, and a third population of candidate passengers for said rideshare vehicles, constructing relationship databases for each of said first, second and third populations, providing a global internet portal for accessing said relationship databases according to predetermined restrictive access criteria and generating an output of potential matches of specific riders, drivers and vehicles according to predetermined correlation criteria thus enabling interactive bargaining between riders and drivers for said potential matches, and verifying a bargained match according to predetermined selection or acceptance criteria.

4. A computer program product adapted for loading into at least one memory of a computer readable tangible medium or into an electronic data processing apparatus, the computer program comprising program code for performing the establishment of a first population of rideshare vehicles, a second associated population of drivers of said rideshare vehicles, and a third population of candidate passengers for said rideshare vehicles and constructing relationship databases for each of said first, second and third populations while providing access to said relationship databases according to predetermined restrictive access criteria, said program code being further capable of generating an output of potential matches of specific riders, drivers and vehicles according to said predetermined correlation criteria to enable interactive bargaining between riders and drivers for said potential matches, and then verifying a bargained match according to said predetermined selection or acceptance criteria.

5. The ridesharing system of claim 1, wherein said system comprises an internet server coupled to a global communications network, and a computer program product adapted to be loaded into said internet server to process of said inputted allocations, effect said computational matching based on said allocations, and outputting results of said computational matching to said potential participants.

6. The ridesharing system of claim 5, wherein said predetermined selection criteria comprise at least one of: quality of a ride experience; speed, ease and/or efficiency of getting to a destination; compatibility of ridesharing participants; and quantitative value exchange involved in a ridesharing transaction.

7. The ridesharing system of claim 5, wherein said predetermined selection criteria comprise a combination of quantitative value exchange involved in a ridesharing transaction and at least one other of: quality of a ride experience; speed, ease and/or efficiency of getting to a destination; compatibility of ridesharing participants; and a measure of risk, the later determined either through system internal calculations and logic, or via external risk quantitation.

8. The ridesharing system of claim 1, wherein the quantitative total budget of allocatable value comprises a total ride satisfaction budget of a predetermined number of units.

9. The ridesharing system of claim 7, wherein the quantitative total budget of allocatable value comprises a same predetermined number of units for all potential participants.

10. The ridesharing system of claim 1, wherein the system is programmatically arranged to effect a best matching approach to available selectees of the system for the ridesharing arrangement from among said potential participants.

11. The ridesharing system of claim 1, including capability for alternative public or private identity descriptors selectable by a potential participant.

12. The ridesharing system of claim 1, in which the system is constructed and arranged so that the computational matching comprises matching of a driver to at least one potential rider to minimize travel distance involving a series of destinations.

13. The computer program product of claim 4, wherein said computer program comprises code enabling access to and communication with the relationship databases storing driver and potential rider information.

14. The ridesharing system of claim 1, wherein the system is constructed and arranged so that a driver and the rider are involved in negotiated ridesharing participation independently of one another, utilizing separate subsystems or external systems adapted to communicate with one another via a predetermined ridesharing protocol.

15. The ridesharing system of claim 1, wherein one of the predetermined selection criteria is a qualitative or quantitative measure of risk provided by a third party through a database that is communicatively linked via the internet to an internet server running program code of the ridesharing system.

16. The ridesharing system of claim 1, wherein the system is constructed and arranged for:
(a) ridesharing optimization in which user feedback is employed to modify computational matching algorithms to improve at least one of (i) user satisfaction, and (ii) system operational parameters selected from the group consisting of (A) computational time of said computational matching, and (B) system data storage requirements for said computational matching;
(b) use of the system, or elements thereof, with another system that acts to computationally determine an optimum vehicle travel plan including multiple stops and destinations.

17. The ridesharing system of claim 1, wherein the system includes capability for estimating, and outputting to said potential participants during ongoing computational matching, the time a driver must travel to reach a location of a potential rider.

18. The ridesharing system of claim 1, wherein said system is constructed and arranged to communicatively link potential participants during ongoing computational matching.

19. The ridesharing system of claim 1, wherein the system is constructed and arranged to collect and assimilate feedback from participants after completion of a ridesharing event, wherein the feedback characterizes the ridesharing event qualitatively and/or quantitatively.

20. The ridesharing system of claim 19, wherein the system is constructed and arranged to utilize assimilated feedback data to computationally modify algorithms for rider and ride provider matching, in order to improve likelihood of a favorable ridesharing experience in a future ridesharing computation matching.

21. The ridesharing system of claim 1, wherein the system is constructed and arranged to comprise at least one of the following characteristics:
(a) computational matching comprising use of multiple disparate matching criteria including quantitative matching criteria and qualitative matching criteria;
(b) computational matching comprising use of use of matching criteria including risk determination criteria;
(c) computational matching including user-generated weighting of disparate input criteria;
(d) ridesharing optimization in which user feedback is employed to modify computational matching algorithms to improve at least one of (i) user satisfaction, and (ii) system operational parameters selected from the group consisting of (A) computational time of said computational matching, and (B) system data storage requirements for said computational matching;
(e) use of the system, or elements thereof, with another system that acts to computationally determine an optimum vehicle travel plan including multiple stops and destinations.

22. The system of claim 21, wherein the system is constructed and arranged to comprise characteristics (a), (b) and (c).

23. The system of claim 22, wherein said disparate input criteria include said multiple disparate matching criteria and said risk determination criteria.

24. The system of claim 21, wherein the system is constructed and arranged to comprise characteristic (d).

25. The system of claim 24, wherein the matching algorithms are modified to improve user satisfaction and said system operational parameters (A) and (B).

26. The system of claim 21, wherein the system is constructed and arranged to comprise characteristic (e).

27. The system of claim 21, wherein the system is constructed and arranged to comprise all of said characteristics (a)-(e).
